(19) United States
(12) Patent Application Publication
(10) Pub. No.: US 2025/0182943 A1
(43) Pub. Date: Jun. 5, 2025

(54) Electronic circuit for actuating an electromagnetic linear actuator

(71) Applicant: Murrelektronik GmbH, Oppenweiler (DE)

(72) Inventors: Jonny Rödiger, Zwenkau (DE); Ingo Wolff, Öhringen (DE)

(73) Assignee: Murrelektronik GmbH, Oppenweiler (DE)

(21) Appl. No.: 18/967,874

(22) Filed: Dec. 4, 2024

(30) Foreign Application Priority Data
Dec. 5, 2023 (EP) 23214312.3

(51) Int. Cl. H01F 7/06; H01F 7/18

(52) U.S. Cl. CPC H01F 7/064; H01F 7/1816

(57) ABSTRACT

An electronic circuit for actuating an electromagnetic linear actuator includes a ground input for a DC voltage source, a ground output to the electromagnetic linear actuator, a supply input for connecting the DC voltage source, a load output to the electromagnetic linear actuator, a first switch for selectively disconnecting the load output from the supply input, a second switch for selectively disconnecting the ground output from the ground input, and a control unit for controlling the first switch and the second switch. The load output is connected to the ground input by a first electronic valve and the ground output to an input side of the first switch by a second electronic valve, which each provide electrical connections in order to conduct an induction current induced in the electromagnetic linear actuator after opening of the electronically controllable switches.

### CROSS-REFERENCE TO RELATED APPLICATION

This application claims the benefit of European Patent Application EP 23214312.3, filed on Dec. 5, 2023, the content of which is incorporated in its entirety.

### TECHNICAL FIELD

The disclosure relates to an electronic circuit for actuating an electromagnetic linear actuator. Electromagnetic linear actuators are used, for example, to actuate valves, relays, contactors, and the like.

### BACKGROUND

An electromagnetic linear actuator is an electrically actuated motor with a stator and an armature mounted moveably on the stator in such a way that the armature can move in translation relative to the stator, i.e. can move along a mostly straight line. The armature can be elastically prestressed into a rest position of the armature by a spring that is fixed in place relative to the stator. In the rest position, the armature is usually arranged partially outside the stator or next to the stator in relation to a direction of movement of the stator. A maximum distance of the translatory movement between the rest position and a working position of the armature is referred to as a stroke of the electromagnetic linear actuator.

The stator and the armature can each comprise electromagnets or a soft magnetic, in particular ferromagnetic material. Each electromagnet usually comprises an electric coil with a self-inductance. The electric coil comprises an electric wire, for example a copper wire, which is wound in a plurality of turns. The electric coil of the electromagnetic linear actuator can comprise a plurality of windings.

When an electric current flows in the electric coil, the electric coil generates a magnetic field and magnetizes the soft magnetic core of the armature, whereby the armature is subjected to a force and accelerated in the, in particular constant, magnetic field provided by the electric coil. If the armature is elastically prestressed into the rest position by a spring, the armature is accelerated from the rest position against an elastic restoring force of the spring.

The electromagnetic linear actuator is actuated by a suitable electronic circuit. The electronic circuit connects the electromagnetic linear actuator to an electrical voltage source which provides an electrical potential difference, referred to as the supply voltage, for actuating the electromagnetic linear actuator.

The electronic circuit comprises at least one electronically controllable switching element for selectively connecting and disconnecting the electromagnetic linear actuator to and from the voltage source and can comprise a plurality of other electronic components. A switching element, or switch for short, is electronically controllable if it enables actuation by an electrical signal and, in particular, automatic actuation.

An intended operating cycle of the electromagnetic linear actuator can be divided into four phases: a starting phase, until the armature leaves the rest position, a flight phase, during which the armature moves from the rest position into the working position, a holding phase during which the armature remains in the working position, and a dropout phase during which the armature moves back into the rest position. During intended operation, several operating cycles usually follow one another.

To initiate the starting phase, the electromagnetic linear actuator is supplied with the supply voltage of a voltage source, i.e. an electrical potential difference, by electrically connecting the electric coil to the voltage source by closing the at least one electronically controllable switching element. An electric current then flowing through the electric coil provides an induction voltage by self-induction of the electric coil, which is polarized in the opposite direction to the supply voltage in accordance with Lenz's law and counteracts the electric current. As a result of the induction voltage, the electric current does not increase abruptly, but steadily.

When the magnetic field generated by the coil reaches a minimum strength, the armature leaves the rest position and the electromagnetic linear actuator enters the flight phase. The minimum strength can be defined by an elastic restoring force of a spring. During the flight phase, the strength of the generated magnetic field continues to increase asymptotically up to a maximum strength. The armature finally reaches the working position. The armature advancing in the direction of the stator increases the self-inductance of the electric coil.

When the working position is reached, the holding phase can begin, during which the armature remains in the working position and the strength of the generated magnetic field is maintained while compensating for ohmic losses in the electric coil. The magnetic field generated by the electric coil in the holding phase stores electrical energy. In addition, a spring deflected in the holding position can store mechanical energy.

By opening at least one electronically controllable switching element, the electromagnetic linear actuator is disconnected from the supply voltage, which initiates the final dropout phase. By self-induction, the electric coil provides an induction voltage that is polarized in the opposite direction to the supply voltage in accordance with Lenz's law. As a result of the increased self-inductance of the electric coil in the operating position, the induction voltage can be so high that the electronically controllable switching element used to disconnect the electromagnetic linear actuator from the current source is damaged or destroyed, for example by an electrical breakdown or a switching spark or a switching arc.

In order to limit the level of the induction voltage, the electronic circuit can comprise an electronic valve that connects the terminals of the electric coil. An electronic valve is understood here and below to mean an electronic component that usually comprises at least one PN junction and can prevent a current flow through the electronic component depending on the voltage. By way of example, diodes, bidirectional diodes and varistors are electronic valves. A bidirectional diode is also referred to as a DIAC (diode for alternating current).

A diode comprises exactly two oppositely doped semiconductor regions, which are referred to as a PN junction. The PN junction allows a current flow in a forward direction above a so-called threshold voltage and prevents the current flow in a reverse direction opposite to the forward direction below a so-called breakdown voltage. A varistor is a voltage-dependent resistor that prevents a flow of current in any direction below a so-called varistor voltage and enables it above the varistor voltage.

A diode as an electronic valve is arranged in the reverse direction in relation to the supply voltage and only provides a short circuit for the electric coil for an electric current flowing against the supply voltage. Due to the self-induction of the electric coil, the electric current flowing through the electronic valve does not decrease abruptly, but instead decreases steadily and exponentially. In this way, the energy stored in the electromagnetic linear actuator is substantially transformed into ohmic heat loss by the electric coil and remains unutilized.

Due to the electric current that continues to flow after the electromagnetic linear actuator is disconnected from the supply voltage, which is subsequently referred to as an induced induction current, the magnetic field generated by the electric coil does not decrease abruptly, but instead decreases steadily and exponentially. As a result, a return of the armature from the working position to the rest position and thus a subsequent starting electronic circuit for actuating an electromagnetic linear actuator is delayed. Apart from this, the ohmic heat loss generated during each cycle of the electromagnetic linear actuator can prevent a fast cycle sequence.

### SUMMARY

The disclosure provides an electronic circuit for an electromagnetic linear actuator which enables utilization of an electrical energy stored in the electromagnetic linear actuator in a dropout phase of the electromagnetic linear actuator and a fast cycle sequence of the electromagnetic linear actuator and protects an electronically controllable switching element used to actuate the electromagnetic linear actuator from a harmful induction voltage of the electromagnetic linear actuator. The disclosure further describes a connector and an electromagnetic linear actuator.

An electronic circuit for actuating an electromagnetic linear actuator comprises a ground input for connecting a negative pole of a DC voltage source, a ground output for connecting a first pole of the electromagnetic linear actuator, a supply input for connecting a positive pole of the DC voltage source, a load output for connecting a second pole of the electromagnetic linear actuator, a first, in particular electronically controllable, switching element for selectively disconnecting the load output from and connecting the load output to the supply input, wherein the first switching element is to be opened for disconnecting the load output from the supply input, a second, in particular electronically controllable, switching element for selectively disconnecting the ground output from and connecting the ground output to the ground input, wherein the second switching element is to be opened for disconnecting the ground output from the ground input, and a control unit connected to a control input of the first switching element and a control input of the second switching element for controlling the first switching element and the second switching element. In particular, the supply input and the ground input form an input side of the electronic circuit for connecting the DC voltage source. In particular, the load output and the ground output form an output side of the electronic circuit for connecting the electromagnetic linear actuator. The supply input, the ground input, the load output and the ground output serve to define the electronic circuit and can be physically designed as connection contacts. However, it is also conceivable that these are merely imaginary points in the respective lines.

The first switching element and the second switching element enable the outputs of the electronic circuit to be disconnected from the inputs of the electronic circuit. The switching elements can be used to completely disconnect the electromagnetic linear actuator from the DC voltage source. Preferably, the control unit is designed to actuate the first electronically controllable switching element and the second electronically controllable switching element synchronously, i.e. to open and close them simultaneously.

Furthermore, the electronic circuit comprises a first electronic valve connecting the load output to the ground input and a second electronic valve connecting the ground output to an input side of the first switching element, which provide electrical connections from the second pole of the electromagnetic linear actuator to the ground input and from the first pole of the electromagnetic linear actuator to the input side of the first switching element, respectively, in order to conduct an induction current induced in the electromagnetic linear actuator after opening of the electronically controllable switching elements. The first electronic valve and the second electronic valve are designed as diodes or varistors, for example, and are designed and arranged in such a way that they block a current provided by the DC voltage source, or supply current for short. In other words, the electronic valves do not generate a short circuit when the electronically controllable switching elements are closed, i.e. during the starting phase, the flight phase and the holding phase of the electromagnetic linear actuator. In particular, the supply current flows from one pole of the DC voltage source through the closed switching elements and the electromagnetic linear actuator to the other pole.

The electronic valves allow the induction current to flow out of the electromagnetic linear actuator, in particular in the dropout phase, thereby preventing a damaging overvoltage and allowing energy stored in the electromagnetic linear actuator, i.e. electrical energy from the magnetic field and possibly mechanical energy from the spring, to be utilized.

The electronic valves connect the ground output to the supply input and the load output to the ground input. In particular, in this way, the induced induction current flows into the direct current source after the electronically controllable switching elements are opened. In other words, the energy stored in the electromagnetic linear actuator is fed into the direct current source and is not lost as ohmic heat loss.

The electronic circuit can comprise an electrical energy storage device connected to the ground input and the second electronic valve, which is charged by the induced induction current. The electrical energy storage device is appropriately designed to be charged by the induction current, i.e. to absorb the energy stored in the electromagnetic linear actuator after the holding phase and store it for later use.

In one embodiment, the electrical energy storage device and the second electronic valve are connected to the supply input. In this way, the DC voltage source can pre-charge the electrical energy storage device at least substantially to a supply voltage provided by the DC voltage source. The electrical lines between the supply input and the electrical energy storage device and between the ground input and the electrical energy storage device, as well as any other electronic components through which a pre-charging current provided by the DC voltage source flows, can be referred to as a pre-charging circuit of the voltage arrangement.

Pre-charging means charging the electrical energy storage device by an electrical charging current provided by the DC voltage source. The pre-charged energy storage device shortens the starting phase that begins when the electronically controllable switching elements close and improves the response behavior of the electromagnetic linear actuator. In particular, heating of the electronic circuit is prevented or at least reduced.

The electronic circuit advantageously includes a third electronic valve that connects the supply input to the electrical energy storage device. The third electronic valve enables a charging voltage of the electrical energy storage device that is greater than the supply voltage provided by the DC voltage source.

Favorably, the electronic circuit comprises a DC/DC converter with an input connected to the electrical energy storage device and an output for connecting a further electronic circuit. The DC/DC converter converts an electrical voltage provided by the energy storage device into an electrical operating voltage required by the additional electronic circuit. In this way, the further electronic circuit can be operated as intended independently of the electrical voltage provided by the electrical energy storage device. The combination of the DC/DC converter and the additional electronic circuit can be referred to as a discharge circuit of the electronic circuit.

A further electronic circuit for actuating an electromagnetic linear actuator comprises a ground input for connecting a negative pole of a DC voltage source, a ground output connected to the ground input for connecting a first pole of the electromagnetic linear actuator, a supply input for connecting a positive pole of the DC voltage source, a load output for connecting a second pole of the electromagnetic linear actuator, a first, in particular an electronically controllable, switching element, for selectively disconnecting and connecting the load output from the supply input, wherein the first switching element is to be opened for disconnecting the load output from the supply input, and a control unit connected to a control input of the first switching element for controlling the first switching element.

In particular, the electronic circuit does not include a second electronically controllable switching element. As a result, the ground output and the second pole of the electromagnetic linear actuator are permanently electrically connected. The electromagnetic linear actuator is not potential-free, which offers advantages in terms of circuitry and/or measurement technology.

Preferably, the electronic circuit comprises an electrical energy storage device, a first electronic valve connecting the electrical energy storage device to the load output, which allows further charging of the electrical energy storage device with an induction current induced in the electromagnetic linear actuator, and a pre-charging and discharging circuit for pre-charging and discharging the electrical energy storage device to a supply voltage provided by the DC voltage source, wherein the electrical energy storage device can be connected to the electromagnetic linear actuator in such a way that, after the first switching element is opened, the induction current induced in the electromagnetic linear actuator is conducted to the electrical energy storage device and charges it further. The pre-charging and discharging circuit ensures that the electrical energy storage device is pre-charged to the supply voltage before the first electronically controllable switching element is closed by a charging current provided by the DC voltage source. Pre-charging the electrical energy storage device improves the response behaviour of the electromagnetic linear actuator. Further charging charges the electrical energy storage device even more after pre-charging.

The pre-charging and discharging circuit also ensures that the electrical energy storage device is discharged to the supply voltage after the first electronically controllable switching element is opened. A discharge current provided by the electrical energy storage device can flow through the pre-charging and discharging circuit into the DC voltage source. This prevents damaging overvoltage in the dropout phase of the electromagnetic linear actuator. The energy stored in the electromagnetic linear actuator is fed into the DC source and is not lost as heat due to ohmic losses.

Preferably, the electronic circuit comprises a plurality of electronically controllable first switching elements, load outputs and first electronic valves. The electronic circuit can actuate a plurality of electromagnetic linear actuators independently of one another. The second poles of the electromagnetic linear actuators are connected to the ground output of the electronic circuit and are at the same electrical potential. The first pole of each electromagnetic linear actuator is connected to exactly one load output. The electrical energy storage device of the pre-charging and discharging circuit is designed to absorb the stored energy of all electromagnetic linear actuators during the respective dropout phases and to release it again during discharging in order to feed it into the DC voltage source.

The electronic circuit can also comprise at least a second electronic valve that connects the ground output to the energy storage device and allows the electrical energy storage device to be charged further with the induction current induced in the electromagnetic linear actuator.

In one embodiment, the pre-charging and discharging circuit comprises a bidirectional charge pump that provides the electrical energy storage device connected to the ground input, the ground output and the first electronic valve connected to the load output. The bidirectional charge pump is advantageously designed to transport, i.e. pump, electrical energy from the DC voltage source into the electrical energy storage device or from the electrical energy storage device into the DC voltage source. The transportation is preferably carried out in several steps and periodically.

In particular, the bidirectional charge pump comprises an additional electrical energy storage device for charging and discharging the electrical energy storage device. The additional electrical energy storage device acts as an intermediate storage device for the electrical energy transported bidirectionally between the DC voltage source and the electrical energy storage device.

The pre-charging and discharging circuit can comprise at least one third electronically controllable switching element with a control input connected to the control unit, via which the electrical energy storage device can be pre-charged or discharged to the voltage provided by the DC voltage source. Each third electronically controllable switching element is used to start and end a pumping step. In particular, several, in particular four, third electronically controllable switching elements can be opened and closed in pairs synchronously and alternately in order to start and end a pumping step.

Advantageously, the pre-charging and discharging circuit comprises at least one coil, a second electronic valve and/or a pre-charging resistor, via which the electrical energy storage device can be pre-charged. As part of the bidirectional charge pump, the at least one coil can reduce ohmic losses during pumping.

The second electronic valve and/or the pre-charging resistor can belong to a pre-charging and discharging circuit that is different from the bidirectional charge pump. The pre-charging resistor can limit a pre-charging current provided by the DC voltage source. The pre-charging and discharging circuit can comprise a plurality of pre-charging resistors.

Preferably, at least one of the electrical energy storage devices, in particular each electrical energy storage device, is designed as a capacitor. The capacitor is very suitable for storing electrical energy. Capacitors with different capacitances are available, such that the capacitor can be selected to suit the electromagnetic linear actuator. Of course, the electrical energy storage device can comprise a plurality of capacitors, in particular in a parallel circuit.

Each electronically controllable switching element can be designed as a bipolar transistor, IGBT, a field-effect transistor (FET), a thyristor or a relay. The IGBT is a bipolar transistor with an insulated gate electrode (insulated-gate bipolar transistor). Bipolar transistors can switch higher currents than conventional transistors. The thyristor comprises four or more than four semiconductor layers with alternating doping. While electrons and defect electrons, i.e. holes, can contribute to charge transport in bipolar transistors, either electrons or holes contribute to charge transport in field-effect transistors. The respective control inputs are referred to as a base or gate.

The DC voltage source connected to the supply input and the ground input, into which the induced induction current is fed, can also be part of the electronic circuit. During the dropout phase, the DC voltage source absorbs the energy stored in the electromagnetic linear actuator.

A connector for controlling a solenoid valve comprises an electronic circuit according to one embodiment of the disclosure and an electromagnetic linear actuator connected on the output side to the electronic circuit. The connector comprises a housing in which the electronic circuit and the electromagnetic linear actuator are arranged, and is a compact, efficient and reliable component that is easy to handle.

A linear actuator comprises an electronic circuit according to one embodiment of the disclosure. The linear actuator comprises a housing in which the electronic circuit is arranged, and is a compact, efficient and reliable component which has universal usability and is particularly suitable for continuous operation.

A major advantage of the disclosed electronic circuit is that electrical energy stored in an electromagnetic linear actuator can be utilised. In this way, the efficiency of the electromagnetic linear actuator is increased. In addition, the electronic circuit enables a fast cycle sequence of the electromagnetic linear actuator. Furthermore, the electronic circuit protects an electronically controllable switching element used to operate the electromagnetic linear actuator from a harmful induction voltage of the electromagnetic linear actuator. Apart from this, the electronic circuit according to the invention makes it possible to provide an integrated connector for a valve or a compact electromagnetic linear actuator.

### BRIEF DESCRIPTION OF THE DRAWINGS

Exemplary embodiments of the invention are explained below with reference to the drawing.

FIG. 1 shows a schematic representation of a circuit diagram of an electronic circuit according to a first embodiment for actuating an electromagnetic linear actuator,

FIG. 2 shows a schematic representation of a circuit diagram of an electronic circuit according to a second embodiment for actuating an electromagnetic linear actuator,

FIG. 3 shows a schematic representation of a circuit diagram of an electronic circuit according to a third embodiment for actuating an electromagnetic linear actuator, and

FIG. 4 shows a schematic representation of a circuit diagram of an electronic circuit according to a modification of the first embodiment for actuating an electromagnetic linear actuator.

### DETAILED DESCRIPTION

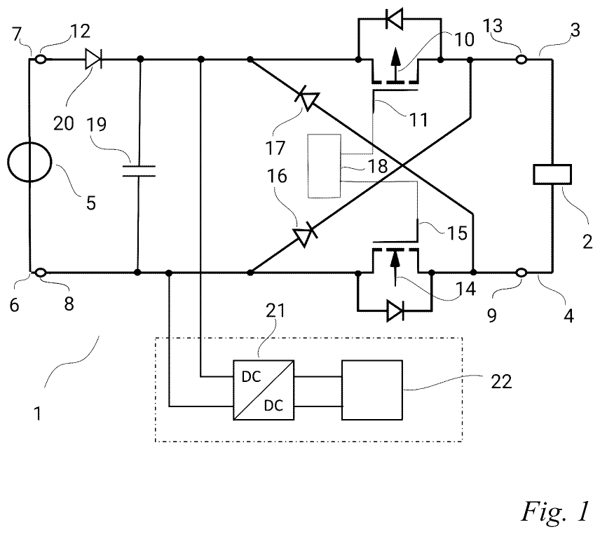

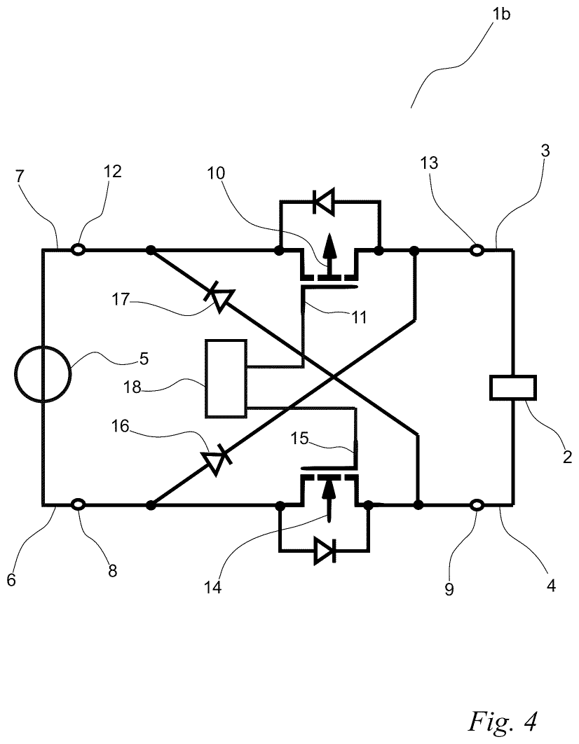

FIG. 1 shows an electronic circuit 1 according to a first embodiment for actuating an electromagnetic linear actuator 2. FIG. 4 shows a modification of this first embodiment as an electronic circuit 1b. The following description applies to both FIG. 1 and FIG. 4. The electronic circuit 1 comprises a ground input 8 for connecting a negative pole 6 of a DC voltage source 5 and a ground output 9 for connecting a first pole 4 of the electromagnetic linear actuator 2. The electronic circuit 1 further comprises a supply input 12 for connecting a positive pole 7 of the DC voltage source 5 and a load output 13 for connecting a second pole 3 of the electromagnetic linear actuator 2.

The electronic circuit 1 further comprises a first, in particular electronically controllable, switching element 10 for selectively disconnecting the load output 13 from and connecting the load output 13 to the supply input 12. To disconnect the load output 13 from the supply input 12, the first switching element 10 must be opened. The electronic circuit 1 also comprises a second, in particular electronically controllable, switching element 14 for selectively disconnecting the ground output 9 from and connecting the ground output 9 to the ground input 8. To disconnect the ground output 9 from the ground input 8, the second switching element 14 must be opened. Each electronically controllable switching element 10, 14 is designed, for example, as a bipolar transistor, IGBT, a field-effect transistor (FET), a thyristor or a relay.

The electronic circuit 1 includes a control unit 18 for controlling the first switching element 10 and the second switching element 14. The control unit 18 is connected to a control input 11 of the first switching element 10 and a control input 15 of the second switching element 14. The control unit 18 can be designed to actuate the first switching element 10 and the second switching element 14 synchronously.

The electronic circuit comprises a first electronic valve 16, which connects the load output 13 to the ground input 8, and a second electronic valve 17, which connects the ground output 9 to an input side of the first switching element 10. In the exemplary embodiments, the electronic valves 16 and 17 are diodes. However, it can also be provided that the electronic valves are varistors or bidirectional diodes (DIACs). The electronic valves 16, 17 each provide electrical connections from the second pole 3 of the electromagnetic linear actuator 2 to the ground input 8 and from the first pole 4 of the electromagnetic linear actuator 2 to the input side of the first switching element 10. The electrical connections serve to conduct an induction current induced in the electromagnetic linear actuator 2 after the electronically controllable switching elements 10, 14 are opened.

The electronic circuit 1 according to FIG. 1 advantageously comprises an electrical energy storage device 19 connected to the ground input 8 and the second electronic valve 17, which is charged by the induced induction current. The electrical energy storage device 19 and the second electronic valve 17 are preferably connected to the supply input 12. In the electronic circuit 1b according to FIG. 4, no such electrical energy storage device 19 is provided.

The electrical energy storage device 19 can be designed as a capacitor. In this case, the electronic circuit 1 advantageously comprises a third electronic valve 20, which connects the supply input 12 to the electrical energy storage device 19. In the exemplary embodiment according to FIG. 1, the third electronic valve 20 is a diode. In the modified electronic circuit 1b according to FIG. 4, no such third electronic valve 20 is provided. This allows an induction current induced in the electromagnetic linear actuator 2 to flow into the DC voltage source 5, in particular after the first switching element 10 and/or the second switching element 14 has opened.

In addition to the electrical energy storage device 19, the electronic circuit 1 according to FIG. 1 can have a DC/DC converter 21 with an input connected to the electrical energy storage device 19 and an output for connecting a further electronic circuit 22. The further electronic circuit 22 can also belong to the electronic circuit 1. In the electronic circuit 1b according to FIG. 4, no such DC/DC converter 21 and also no such further electronic circuit 22 is provided.

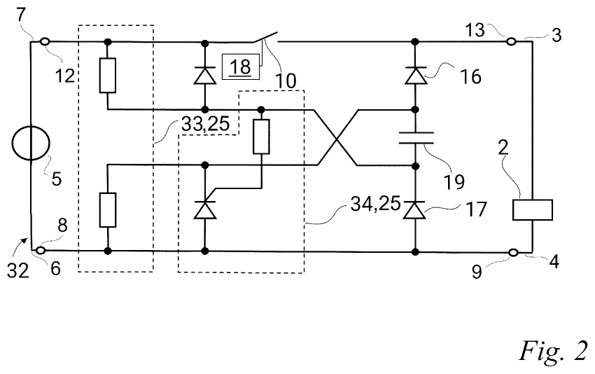

FIG. 2 shows an electronic circuit 24 according to a second embodiment for actuating an electromagnetic linear actuator 2. The electronic circuit 24 comprises a ground input 8 for connecting a negative pole 6 of a DC voltage source 5 and a ground output 9 connected to the ground input 8 for connecting a first pole 4 of the electromagnetic linear actuator 2.

Furthermore, the electronic circuit 24 comprises a supply input 12 for connecting a positive pole 7 of the DC voltage source 5 and a load output 13 for connecting a second pole 3 of the electromagnetic linear actuator 2.

The electronic circuit 24 also includes a first, in particular electronically controllable, switching element 10 for selectively disconnecting and connecting the load output 13 from the supply input 12. To disconnect the load output 13 from the supply input 12, the first electronically controllable switching element 10 is to be opened. The first electronically controllable switching element 10 can be designed as a bipolar transistor, IGBT, a field-effect transistor (FET), a thyristor or a relay. In contrast to the electronic circuit 1 shown in FIG. 1, the electronic circuit 24 does not comprise a second electronically controllable switching element, i.e. the ground output 9 is electrically inseparably connected to the ground input 8.

The electronic circuit 24 further comprises a control unit 18 for controlling the first switching element 10, which is connected to a control input (not shown) of the first switching element 10.

The electronic circuit 24 comprises an electrical energy storage device 19, a first electronic valve 16 connecting the electrical energy storage device 19 to the load output 13 and allowing further charging of the electrical energy storage device 19 with an induction current induced in the electromagnetic linear actuator 2, and a pre-charging and discharging circuit 25 for pre-charging and discharging the electrical energy storage device 19 to a supply voltage provided by the DC voltage source 5. The electrical energy storage device 19 can be designed as a capacitor.

The electrical energy storage device 19 is connected to the electromagnetic linear actuator 2 in such a way that after the first switching element is opened, the induction current induced in the electromagnetic linear actuator is conducted to the electrical energy storage device 19 and charges it further, in particular above the level of the supply voltage.

The pre-charging and discharging circuit 25 ideally comprises at least one second electronic valve 17. The second electronic valve 17 connects the ground output 9 to the electrical energy storage device 19 and allows further charging of the electrical energy storage device 19 with the induction current induced in the electromagnetic linear actuator 2.

The pre-charging and discharging circuit 25 can also comprise pre-charging resistors 33, via which the electrical energy storage device 19 can be pre-charged, and a third electronically controllable switching element 34, via which the electrical energy storage device 19 can be discharged to the voltage provided by the DC voltage source 5. The third electronically controllable switching element 34 comprises a thyristor. A cathode of the thyristor is connected to the load output 13 via the first electronic valve 16 on the one hand and to the ground input 8 and the ground output 9 via a pre-charging resistor 33 on the other. An anode of the thyristor is connected to the ground input 8 and the ground output 9. A control input (gate) of the thyristor is connected via a series resistor, which sets an ignition voltage of the thyristor, on the one hand to the ground input 8 and the ground output 9 via the second electronic valve 17, and on the other hand via a pre-charging resistor 33 to the supply input 7.

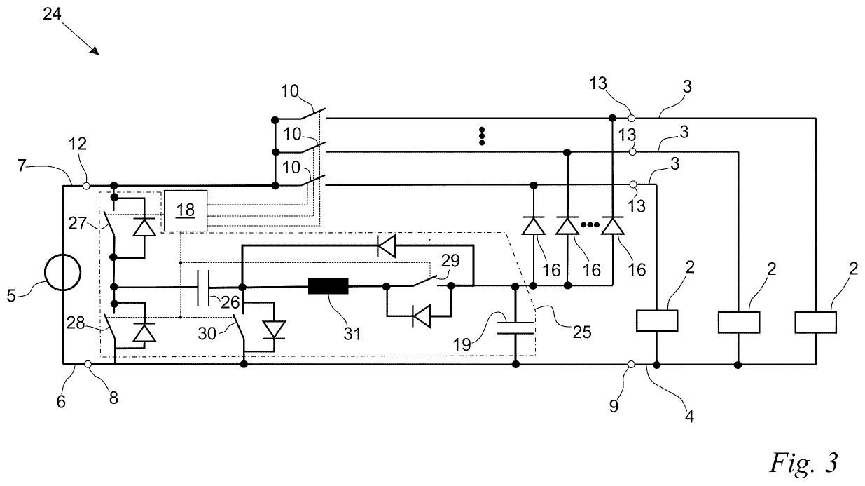

FIG. 3 shows an electronic circuit 32 according to a third for actuating an electromagnetic linear actuator 2. The electronic circuit 32 comprises a ground input 8 for connecting a negative pole 6 of a DC voltage source 5 and a ground output 9 connected to the ground input 8 for connecting a first pole 4 of the electromagnetic linear actuator 2.

Furthermore, the electronic circuit 32 comprises a supply input 12 for connecting a positive pole 7 of the DC voltage source 5 and a load output 13 for connecting a second pole 3 of the electromagnetic linear actuator 2.

The electronic circuit 32 also includes a first, in particular electronically controllable, switching element 10 for selectively disconnecting and connecting the load output 13 from the supply input 12. To disconnect the load output 13 from the supply input 12, the first switching element 10 is to be opened. To connect a plurality of electromagnetic linear actuators 2, the electronic circuit can comprise a corresponding plurality of load outputs 13, electronically controllable first switching elements 10 and first electronic valves 16.

The electronic circuit 32 further comprises a control unit 18 for controlling the first switching element 10, which is connected to a control input (not shown) of the first switching element 10.

The electronic circuit 24 comprises an electrical energy storage device 19, a first electronic valve 16 connecting the electrical energy storage device 19 to the load output 13 and allowing further charging of the electrical energy storage device 19 with an induction current induced in the electromagnetic linear actuator 2, and a pre-charging and discharging circuit 25 for pre-charging and discharging the electrical energy storage device 19 to a supply voltage provided by the DC voltage source 5. The electrical energy storage device 19 can be designed as a capacitor.

The pre-charging and discharging circuit 25 can comprise a bidirectional charge pump that provides the electrical energy storage device 19. The electrical energy storage device 19 is connected to the ground input 8, the ground output 9 and the first electronic valve 16 connected to the load output 13.

The electrical energy storage device 19 is connected to the electromagnetic linear actuator 2 in such a way that after the first switching element 10 is opened, the induction current induced in the electromagnetic linear actuator 2 is conducted to the electrical energy storage device 19 and charges it further. The bidirectional charge pump can comprise a further electrical energy storage device 26 for charging and discharging the electrical energy storage device 19. The further electrical energy storage device 26 can be designed as a capacitor.

The bidirectional charge pump advantageously comprises at least one third electronically controllable switching element, in this case four electronically controllable switching elements 27, 28, 29, 30, each having a control input (not shown) connected to the control unit 18, via which the electrical energy storage device 19 can be pre-charged in particular to the supply voltage provided by the DC voltage source 5, or discharged to the voltage provided by the DC voltage source 5. Each electronically controllable switching element 10, 14, 27, 28, 29, 30 is designed, for example, as a bipolar transistor, IGBT, a field-effect transistor (FET), a thyristor or a relay.

The pre-charging and discharging circuit 25 can comprise at least one coil 31. The coil 31 serves to minimise energy losses. Energy can be temporarily stored in the magnetic field of the coil 31 by the coil 31 and then passed on to the electrical energy storage device 19 and/or to the further electrical energy storage device 26. This prevents energy from being lost in the form of heat. In the exemplary embodiment, the coil 31 is electrically arranged between the DC voltage source 5 and the electrical energy storage device 19. Advantageously, the coil 31 is electrically arranged between the electrical energy storage device 19 and the further electrical energy storage device 26.

In the exemplary embodiment according to FIG. 3, the further electrical energy storage device 26 is electrically connected to the positive pole 7, in particular to the supply input 12, via the first further electronically controllable switching element 27. The negative pole 6, in particular the ground input 8, is electrically connected to the electrical energy storage device 26 via the second further electronically controllable switching element 28. The third further electronically controllable switching element 29 is electrically arranged between the electrical energy storage device 19 and the further electrical energy storage device 26, in particular the coil 31. The fourth further electronically controllable switching element 30 electrically connects the electrical connection between the electrical energy storage device 19 and the further electrical energy storage device 26, in particular between the electrical energy storage device 26 and the coil 31, to the negative pole 6, in particular to the ground output 8. The further electrical energy storage device 26 is electrically arranged between the electrical energy storage device 19 and the negative pole 6, in particular the ground input 8. The electrical energy storage device 19 and the further electrical energy storage device 26 can be electrically connected via the second further electronically controllable switching element 28.

The first further electronically controllable switching element 27 is bridged by an electronic valve which allows current flow in the conventional current direction from the further electrical energy storage device 26 to the positive pole 7, in particular to the supply input 12, and blocks it in the opposite direction. The second further electronically controllable switching element 28 is bridged by an electronic valve that allows current flow from the electrical energy storage device 19 to the further electrical energy storage device 26 in the conventional current direction and blocks it in the opposite direction. The third further electronically controllable switching element 29 is bridged by an electronic valve which allows current flow from the electrical energy storage device 19 to the further electrical energy storage device 26 in the conventional current direction and blocks it in the opposite direction. The fourth further electronically controllable switching element 30 is bridged by an electronic valve that allows current to flow in the conventional direction from the further electrical energy storage device 26 to the negative pole 6, in particular to the ground input 8, and blocks it in the opposite direction.

To pre-charge the electrical energy storage device 19, the further electrical energy storage device 26 is charged first. Here, the first further electronically controllable switching element is closed so that charge can flow through it and the further electrical energy storage device 26 can be charged. The fourth further electronically controllable switching element 30 is open and is bridged via the associated electronic valve. One side of the further electrical energy storage device 26, which is designed as a capacitor in the exemplary embodiment, is then electrically connected to the positive pole 7, in particular to the supply input 12, via the first further electronically controllable switching element 27. The other side of the further electrical energy storage device 26, which is designed as a capacitor in the exemplary embodiment, is then electrically connected to the negative pole 6, in particular to the ground input 8, via the electronic valve assigned to the fourth further electronically controllable switching element 30. The second further electronically controllable switching element 28 and the third further electronically controllable switching element 29 are open in this first charging step of the pre-charging and discharging circuit 25.

In a second charging step of the pre-charging and discharging circuit 25, the first further electronically controllable switching element 27 is opened. By the second further electronically controllable switching element 28, the further electrical energy storage device 26, which is charged in particular to the supply voltage, is electrically connected to the negative pole 6, in particular to the ground input 8, in which the switching element is closed. This charges the electrical energy storage device 19. The electrical energy storage device 19 is connected to the further electrical energy storage device 26 via the electronic valve assigned to the third further electronically controllable switching element 29. The third further electronically controllable switching element 29 is open. The electrical energy storage device 19 is charged to a negative potential. The two charging steps can be repeated multiple times, such that the amount of the negative potential of the electrical energy storage device 19 can be greater than the amount of the supply voltage. This process of charging the electrical energy storage device 19 is also referred to as charge pumping.

In a first discharging step of the pre-charging and discharging circuit 25, the first further electronically controllable switching element 27, the second further electronically controllable switching element 28 and the fourth further electronically controllable element 30 are open. The third further electronically controllable switching element 29 is closed. The second further electronically controllable switching element 28 is bridged by the associated electronic valve, such that current can flow in the conventional direction from the further electrical energy storage device 26 to the electrical energy storage device 19 in the first discharging step, irrespective of the position of the second further electronically controllable switching element 28. In this step, the further electrical energy storage device is charged. If the voltage of the first electrical energy storage device 19 is greater or was greater before the first discharging step, the further electrical energy storage device 26 is thereby charged to a voltage that is greater than the supply voltage.

In a second discharging step, the further electrical energy storage device 26 can be discharged in the direction of the supply voltage. Here, the fourth further electronically controllable switching element 30 is closed. All other further switching elements 27, 28 and 29 are open. The current flows in the conventional current direction through the electronic valve assigned to the first further electronically controllable switching element 27.

In this way, the electrical energy storage device 19 can be charged and discharged by the pre-charging and discharging circuit 25. The electrical energy storage device 19 pre-charged by the pre-charging and discharging circuit 25 can be further charged with an induction current induced in the electromagnetic linear actuator 2.

Each electronic circuit, in particular each electronic circuit 1, 1b, 14, 32 described above, can comprise the DC voltage source 5 connected to the supply input 12 and the ground input 8, into which the induced induction current is conducted. Furthermore, an electronic circuit 1, 1b, 14, 32 can belong to an electromagnetic linear actuator 2 or to a connector for controlling a solenoid valve, wherein the connector comprises, in addition to the electronic circuit 1, 1b, 14, 32, an electromagnetic linear actuator 2 connected on the output side to the electronic circuit. The electronic circuit 1, 1b, 14, 32 can be arranged in a housing of the connector or the solenoid valve.

What is claimed is:

1. An electronic circuit (1) for actuating an electromagnetic linear actuator (2), comprising:
a ground input (8) for connecting a negative pole (6) of a DC voltage source (5);
a ground output (9) for connecting a first pole (4) of the electromagnetic linear actuator (2);
a supply input (12) for connecting a positive pole (7) of the DC voltage source (5);
a load output (13) for connecting a second pole (3) of the electromagnetic linear actuator (2);
a first switch (10) for selectively disconnecting the load output (13) from and connecting the load output (13) to the supply input (12), wherein the first switch (10) is to be opened for disconnecting the load output (13) from the supply input (12);
a second switch (14) for selectively disconnecting the ground output (9) from and connecting the ground output (9) to the ground input (8), wherein the second switch (14) is to be opened for disconnecting the ground output (9) from the ground input (8);
a control unit (18) connected to a control input (11) of the first switch (10) and a control input (15) of the second switch (14) for controlling the first switch (10) and the second switch (14); and
a first electronic valve (16) connecting the load output (13) to the ground input (8) and a second electronic valve (17) connecting the ground output (9) to an input side of the first switch (10),
wherein the first electronic valve (16) provides an electrical connection from the second pole (3) of the electromagnetic linear actuator (2) to the ground input (8) and the second electronic valve (17) provides an electrical connection from the first pole (4) of the electromagnetic linear actuator (2) to the input side of the first switch (10), in order to conduct an induction current induced in the electromagnetic linear actuator (2) after opening of the first switch (10) and the second switch (14).

2. The electronic circuit according to claim 1,
further comprising an electrical energy storage device (19) connected to the ground input (8) and the second electronic valve (17),
wherein the electrical energy storage device (19) is charged by the induction current.

3. The electronic circuit according to claim 2,
wherein the electrical energy storage device (19) and the second electronic valve (17) are connected to the supply input (12).

4. The electronic circuit according to claim 2,
further comprising a third electronic valve (20) connecting the supply input (12) to the electrical energy storage device (19).

5. The electronic circuit according to claim 2,
further comprising a DC/DC converter (21) having an input connected to the electrical energy storage device (19) and an output for connecting a further electronic circuit (22).

6. The electronic circuit according to claim 1,
wherein the first switch (10) is a bipolar transistor, an IGBT, a field-effect transistor, a thyristor, or a relay, and
wherein the second switch (14) is a bipolar transistor, an IGBT, a field-effect transistor, a thyristor, or a relay.

7. The electronic circuit according to claim 1,
wherein the DC voltage source (5) is connected to the supply input (12) and the ground input (8), and
wherein the induction current is conducted into the DC voltage source (5).

8. A connector for controlling a solenoid valve, comprising:
the electronic circuit (1) according to claim 1; and
the electromagnetic linear actuator (2) connected on an output side to the electronic circuit (1).

9. The electromagnetic linear actuator (2), comprising the electronic circuit (1) according to claim 1.

10. An electronic circuit (24, 32) for actuating an electromagnetic linear actuator (2), comprising:
a ground input (8) for connecting a negative pole (6) of a DC voltage source (5);
a ground output (9) connected to the ground input (8) for connecting a first pole (4) of the electromagnetic linear actuator (2);
a supply input (12) for connecting a positive pole (7) of the DC voltage source (5);
a load output (13) for connecting a second pole (3) of the electromagnetic linear actuator (2);
a first switch (10) for selectively disconnecting and connecting the load output (13) from the supply input (12), wherein the first switch (10) is to be opened for disconnecting the load output (13) from the supply input (12);
a control unit (18) connected to a control input of the first switch (10) for controlling the first switch (10);
an electrical energy storage device (19);
a first electronic valve (16) connecting the electrical energy storage device (19) to the load output (13), which allows further charging of the electrical energy storage device (19) with an induction current induced in the electromagnetic linear actuator (2); and
a pre-charging and discharging circuit (25) for pre-charging and discharging the electrical energy storage device (19) to a supply voltage provided by the DC voltage source (5),
wherein the electrical energy storage device (19) can be connected to the electromagnetic linear actuator (2) in such a way that, after the first switch (10) is opened, the induction current induced in the electromagnetic linear actuator (2) is conducted to the electrical energy storage device (19) and charges the electrical energy storage device (19) further.

11. The electronic circuit according to claim 10,
wherein the first switch (10) is electronically controllable.

12. The electronic circuit according to claim 10,
wherein the electronic circuit (24, 32) comprises at least one second electronic valve (17) which connects the ground output (9) to the electrical energy storage device (19) and allows further charging of the electrical energy storage device (19) with the induction current induced by the electromagnetic linear actuator (2), and/or
wherein the electronic circuit (24, 32) has a plurality of electronically controllable first switches (10) and first electronic valves (16).

13. The electronic circuit according to claim 10,
wherein the pre-charging and discharging circuit (25) comprises a bidirectional charge pump,
wherein the bidirectional charge pump provides the electrical energy storage device (19),
wherein the electrical energy storage device (19) is connected to the ground input (8), the ground output (9) and the first electronic valve (16) connected to the load output (13), and/or
wherein the pre-charging and discharging circuit (25) comprises a further electrical energy storage device (26) for charging or discharging the electrical energy storage device (19).

14. The electronic circuit according to claim 13,
wherein the electrical energy storage device (19) is a capacitor, and
wherein the further electrical energy storage device (26) is a capacitor.

15. The electronic circuit according to claim 10,
wherein the pre-charging and discharging circuit (25) comprises at least one third electronically controllable switch (27, 28, 29, 30, 34) with a control input connected to the control unit (18), via which the electrical energy storage device (19) can be pre-charged or discharged to the supply voltage provided by the DC voltage source (5).

16. The electronic circuit according to claim 10,
wherein the pre-charging and discharging circuit (25) comprises at least one coil (31) and/or a pre-charging resistor (33) via which the electrical energy storage device (19) can be pre-charged.

17. The electronic circuit according to claim 10,
wherein the electrical energy storage device (19) is a capacitor.

18. The electronic circuit according to claim 10,
wherein the DC voltage source (5) is connected to the supply input (12) and the ground input (8), and
wherein the induction current is conducted into the DC voltage source (5).

19. A connector for controlling a solenoid valve, comprising:
the electronic circuit (24, 32) according to claim 10; and
the electromagnetic linear actuator (2) connected on an output side to the electronic circuit (24, 32).

20. The electromagnetic linear actuator (2), comprising the electronic circuit (24, 32) according to claim 10.
